(19) United States
(12) Patent Application Publication
(10) Pub. No.: US 2017/0232681 A1
(43) Pub. Date: Aug. 17, 2017

(54) 3D PRINTER AND 3D PRINTING METHOD

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventors: Pengbo XU, Shenzhen, Guangdong (CN); Hua GU, Shenzhen, Guangdong (CN); Mei HAN, Shenzhen, Guangdong (CN)

(73) Assignees: Shenzhen China Star Optoelectronics Technology Co., Ltd., Shenzhen, Guangdong (CN); WUHAN CHINA STAR OPTOELECTRONICS TECHNOLOGY CO., LTD, Wuhan, Hubei (CN)

(21) Appl. No.: 14/902,561

(22) PCT Filed: Oct. 23, 2015
(86) PCT No.: PCT/CN2015/092740

§ 371 Date: Jan. 1, 2016

(30) Foreign Application Priority Data
Sep. 18, 2015 (CN) 201510601277.4

(51) Int. Cl. B29C 67/00; B29C 35/08; B33Y 50/02; B33Y 10/00; B33Y 30/00

(52) U.S. Cl. CPC B29C 67/0092; B29C 67/0059; B29C 67/0088; B33Y 10/00; B33Y 30/00; B33Y 50/02; B29C 35/0805; B29C 2035/0827

(57) ABSTRACT

The present invention discloses a 3D printer, comprising a printing chamber, and the printing chamber comprises a printing assembly and a loading platform inside, and the printing assembly is located above the loading platform, and the printing assembly comprises a printing support and a printing head assembly and a curing lamp assembly connected on the printing support, and the printing support is moved along a printing direction, and in the printing direction, the printing head assembly is in front of the curing lamp assembly, and the printing head assembly comprises a main printing head of printing a model mainbody and a sub printing head of printing support material, and material of the model mainbody is photosensitive resin, and a printing temperature inside the printing chamber is lower than a solidification temperature of the support material, and the support material is solidified at the printing temperature.

### CROSS REFERENCE

This application claims the priority of Chinese Patent Application No. 201510601277.4, entitled “3D printer and 3D printing method”, filed on Sep. 18, 2015, the disclosure of which is incorporated herein by reference in its entirety.

### FIELD OF THE INVENTION

The present invention relates to a 3D printing field, and more particularly to a 3D printer and a 3D printing method.

### BACKGROUND OF THE INVENTION

3D printing is one kind of rapid formation technology, which is to manufacture the product by printing layer by layer using powder or curable material on the basis of digital document. It is strong contrast comparing with the material reducing technology used in traditional manufacture industry. The 3D printing is a material establishing manufacture technology, which stacks up material layer by layer to form the final product.

SLA printer (utilizing the light curing stereo formation technology, Stereo lithography, SLA) is one of the earliest commercial 3D printers. Such kind of printer utilizes the UV curable photosensitive resin to form the printing layers. After accomplishing the printing of one layer, the support platform is moved upward or downward a certain distance to make the photosensitive resin recover the previous printing layer, and then to cure it. The photosensitive resin needs to be squeezed out from printing head, and the material stacks up layer by layer. Thus, for a new layer which some part is not in the section of the previous printing layer in the printing process, the necessary support has to be provided. Removing the support part can easily do bad influence to the printing layers, which comprises the deformation or even breakage of the printing layer. Most of the 3D printing technology according to prior art utilizes support material for supporting. The only function of the support material is: 1, fixing the pre-printed model mainbody; 2, the support material can act the support function as printing the hanging part of the pre-printed model mainbody. However, there are four issues existing in the present support materials: 1, the removing process of support material from the model mainbody is more difficult. It requires special solvent, high frequency vibration or other technical means; 2, the removing efficiency of the support material is low and a long time takes; 3, after removing the support material, the remaining partial residual on the model mainbody cannot be avoided.

### SUMMARY OF THE INVENTION

An objective of the present invention is to provide a 3D printer and a 3D printing method.

For realizing the aforesaid objective, the technical solution provided by the embodiments of the present invention is:

on one hand, a 3D printer is provided, which comprises a printing chamber, and the printing chamber comprises a printing assembly and a loading platform inside, and the printing assembly is located above the loading platform, and the printing assembly comprises a printing support and a printing head assembly and a curing lamp assembly connected on the printing support, and the printing support is moved along a printing direction, and in the printing direction, the printing head assembly is in front of the curing lamp assembly, and the printing head assembly comprises a main printing head of printing a model mainbody and a sub printing head of printing support material, and material of the model mainbody is photosensitive resin, and a printing temperature inside the printing chamber is lower than a solidification temperature of the support material, and the support material is solidified at the printing temperature.

The support material is water, and the printing temperature is lower than 0° C.

The printing assembly further comprises a flattening assembly connected on the printing support, and the flattening assembly is positioned between the printing head assembly and the curing lamp assembly.

The flattening assembly comprises a flattening roller and a supporting frame connected to the flattening roller and the printing support.

An interior of the flattening roller and an interior of the supporting frame are hollow and communicate with each other, and the interior of the flattening roller and the interior of the supporting frame are filled with cooling material of which a temperature is lower than the solidification temperature.

The sub printing head comprises a temperature control device of controlling the support material in the sub printing head to remain to be liquid.

In the printing direction, the main printing head is in front of the sub printing head.

The printing assembly further comprises a switch head, and the switch head connects the main printing head and the sub printing head to the printing support, and the switch head switches positions of the main printing head and the sub printing head.

The loading platform comprises a low temperature assembly, and the low temperature assembly controls a temperature of a loading surface of the loading platform to be lower than the solidification temperature of the support material.

On the other hand, a 3D printing method is further provided, and the 3D printing method employs a 3D printer for printing, and the 3D printer comprises a printing chamber, and the printing chamber comprises a printing assembly and a loading platform inside, and the printing assembly is located above the loading platform, and the printing assembly comprises a printing support and a printing head assembly and a curing lamp assembly connected on the printing support, and the printing support is moved along a printing direction, and in the printing direction, the printing head assembly is in front of the curing lamp assembly, and the printing head assembly comprises a main printing head of printing a model mainbody and a sub printing head of printing support material, and material of the model mainbody is photosensitive resin, and a printing temperature inside the printing chamber is lower than a solidification temperature of the support material, and the support material is solidified at the printing temperature.

specific printing steps of the 3D printing method comprises:

printing the photosensitive resin and the support material in the printing chamber to form a model, and the photosensitive resin forms the model mainbody under irradiation of the curing lamp assembly, and the support material is solidified and supports the model mainbody at the printing temperature lower than the solidification temperature of the support material;

taking out the model, and removing the support material in an environment of which a temperature is higher than the solidification temperature of the support material.

The support material is water, and the printing temperature is lower than 0° C.

The printing assembly further comprises a flattening assembly connected on the printing support, and the flattening assembly is positioned between the printing head assembly and the curing lamp assembly.

The flattening assembly comprises a flattening roller and a supporting frame connected to the flattening roller and the printing support.

An interior of the flattening roller and an interior of the supporting frame are hollow and communicate with each other, and the interior of the flattening roller and the interior of the supporting frame are filled with cooling material of which a temperature is lower than the solidification temperature.

The sub printing head comprises a temperature control device of controlling the support material in the sub printing head to remain to be liquid.

In the printing direction, the main printing head is in front of the sub printing head.

The printing assembly further comprises a switch head, and the switch head connects the main printing head and the sub printing head to the printing support, and the switch head switches positions of the main printing head and the sub printing head.

The loading platform comprises a low temperature assembly, and the low temperature assembly controls a temperature of a loading surface of the loading platform to be lower than the solidification temperature of the support material.

Compared with prior art, the present invention possesses benefits below:

In the 3D printer and the 3D printing method according to the present invention, the support material can be solidified after being printed by controlling the printing temperature in the printing chamber, and thus to realize the fixture and support to the model mainbody. The entire process is simple and highly efficient, and is beneficial for promoting the printing efficiency of the 3D printer.

Meanwhile, only needed is to take out the model from the 3D printer, and put the same in an environment of which the temperature is higher than the solidification temperature of the support material, the support material will spontaneously melt. The remove procedure of the support material is fast and simple, and will not cause damage to the model mainbody. The printing quality of the model mainbody can be ensured.

Furthermore, the support material can be water. In comparison with the present support material, the cost of utilizing water to be the support material is extremely low and environmentally friendly, and can be recycled. Then, the printing temperature in the printing chamber is set to be lower than 0° C. Certainly, only needed is to take out the printing accomplished model from the 3D printer of the present embodiment, and put the same in an environment of which the temperature is higher than 0° C., the support material of water will spontaneously melt. The remove procedure of the support material is fast and simple, and will not cause damage to the model mainbody. The printing quality of the model mainbody can be ensured.

Moreover, the 3D printer of the present invention further comprises a flattening assembly, and the flattening surface of the flattening assembly is in a low temperature state which is lower than the solidification temperature of the support material. The flattening roller can promote the solidification of the support material as flattening the support material, and can assure the support strength of the support material.

### BRIEF DESCRIPTION OF THE DRAWINGS

In order to more clearly illustrate the embodiments of the present invention, the following figures will be described in the embodiments are briefly introduced. It is obvious that the drawings are only some embodiments of the present invention, those of ordinary skill in this field can obtain other figures according to these figures without paying the premise.

FIG. 1 is a structure diagram of a 3D printer provided by the present invention.

FIG. 2 is a structure diagram of a flattening assembly in the 3D printer provided by the present invention.

FIG. 3 is a structure diagram of another 3D printer provided by the present invention.

### DETAILED DESCRIPTION OF PREFERRED EMBODIMENTS

For better explaining the technical solution and the effect of the present invention, the present invention will be further described in detail with the accompanying drawings in the specific embodiments.

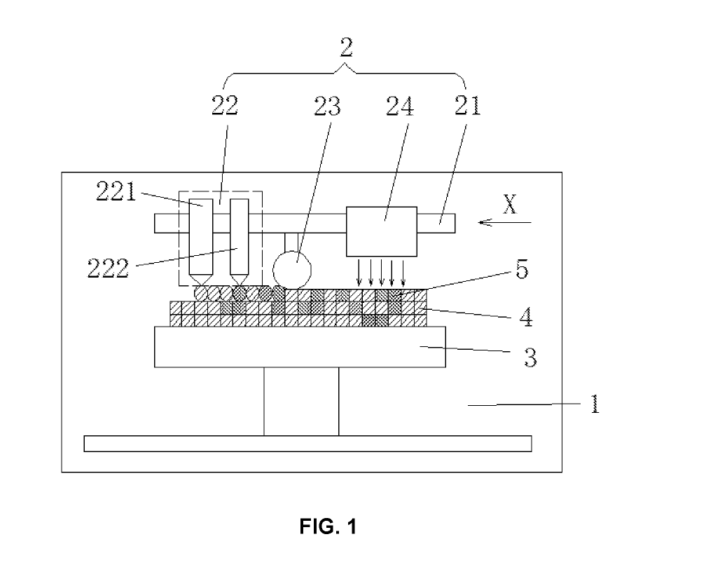

Please refer to FIG. 1. FIG. 1 is a structure diagram of a 3D printer provided by the present invention. The 3D printer according to the embodiment of the present invention comprises a printing chamber 1, and the printing chamber 1 comprises a printing assembly 2 and a loading platform 3 inside, and the printing assembly 2 is located above the loading platform 3, and the printing assembly 2 comprises a printing support 21 and a printing head assembly 22 and a curing lamp assembly 24 connected on the printing support 21. For convenience, the printing direction of the 3D printer of this embodiment is defined to be the X direction shown in FIG. 1. In other words, the printing assembly 2 proceeds printing motion along the X direction. Specifically, the printing support 21 of the printing assembly 2 is moved along the X direction, and in the X direction, the printing head assembly 22 is in front of the curing lamp assembly 24. The printing head assembly 22 comprises a main printing head 221 of printing a model mainbody 4 and a sub printing head 222 of printing support material 5, and material of the model mainbody 4 is photosensitive resin, and a printing temperature inside the printing chamber 1 is lower than a solidification temperature of the support material 5, and the support material 5 is solidified at the printing temperature.

In the 3D printer according to the embodiment of the present invention, the model mainbody 4 is printed by the main printing head 221, and the material of the model mainbody 4 is photosensitive resin, and the model mainbody 4 is solidified under irradiation of the curing lamp assembly 24; the support material 5 is printed by the sub printing head 222, and the support material 5 is printed at the position adjacent to the model mainbody 4 or the hanging position, and is solidified at the printing temperature lower than the solidification temperature of the support material 5 for supporting and fixing the model mainbody 4.

In the 3D printer of this embodiment, the support material 5 can be solidified after being printed by controlling the printing temperature in the printing chamber 1, and thus to realize the fixture and support to the model mainbody 4. The entire process is simple and highly efficient, and is beneficial for promoting the printing efficiency of the 3D printer.

Meanwhile, only needed is to take out the model from the 3D printer, and put the same in an environment of which the temperature is higher than the solidification temperature of the support material 5, the support material 5 will spontaneously melt. The remove procedure of the support material 5 is fast and simple, and will not cause damage to the model mainbody 4. The printing quality of the model mainbody 4 can be ensured.

Furthermore, with utilizing water to be the support material, compared with the support material cost of prior art which is about 700-100 RMB/kg, the cost of this embodiment in which water is utilized to be the support material is extremely low and environmentally friendly, and can be recycled. Then, the printing temperature in the printing chamber 1 is set to be lower than 0° C. Certainly, only needed is to take out the printing accomplished model from the 3D printer of the present embodiment, and put the same in an environment of which the temperature is higher than 0° C., the support material of water will spontaneously melt. The remove procedure of the support material is fast and simple, and will not cause damage to the model mainbody. The printing quality of the model mainbody can be ensured.

It is understandable that the printing temperature inside the printing chamber 1 can be maintained by the wind circulation system. The Cooling source of the wind circulation system can be an external refrigeration system or an auxiliary system of the 3D printer.

Furthermore, as shown in FIG. 1, the printing assembly 2 of the 3D printer further comprises a flattening assembly 23 connected on the printing support 21, and the flattening assembly 23 is positioned between the printing head assembly 22 and the curing lamp assembly 24. In the printing procedure, first, the printing assembly 2 prints the photosensitive resin and the support material, and then the flattening assembly 23 presses the photosensitive resin and the support material with a setting thickness, and finally, the curing lamp assembly 24 solidifies the photosensitive resin to accomplish one printing.

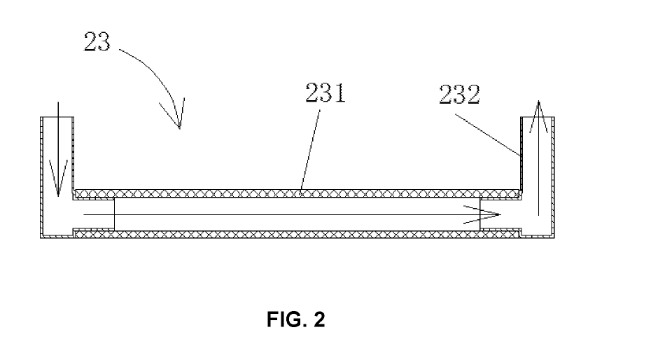

Please refer to FIG. 2. In one preferred embodiment of the present invention, the flattening assembly 23 comprises a flattening roller 231 and a supporting frame 232 connected to the flattening roller 231 and the printing support 21. The flattening roller 231 rolls and flattens the photosensitive resin 4 and the support material 5. The motion is slow and the forward resistance is small. Moreover, an interior of the flattening roller 231 and an interior of the supporting frame 232 are hollow and communicate with each other, and the interior of the flattening roller 231 and the interior of the supporting frame 232 are filled with cooling material of which a temperature is lower than the solidification temperature. As an illustration, the cooling material also can flow in the interior of the flattening roller 231 and the interior of the supporting frame 232. The flowing direction is indicated by the arrow shown in FIG. 2.

The flattening surface of the flattening roller 231 is in a low temperature state which is lower than the solidification temperature of the support material. The flattening roller 231 can promote the solidification of the support material as flattening the support material, and can assure the support strength of the support material. Here, the flattening surface is the outer surface of the flattening roller 231, i.e. the contact surface of the flattening roller 231 with the photosensitive resin and the support material.

It is understandable that when the support material utilizes water to be material, the cooling material can be gas or liquid of −3° C. to −7° C., and preferably of −5° C. Because flattening surface of the flattening roller 231 is in a low temperature state which is lower than 0° C. The flattening roller 231 can solidify the water into ice in advance as flattening the water, and can assure the support strength of the support material which utilizes the water in this embodiment.

Furthermore, the sub printing head 222 of the 3D printer according to the embodiment of the present invention comprises a temperature control device of controlling the support material in the sub printing head 222 to remain to be liquid for preventing the support material from being solidified at the mouth of the sub printing head 222 to form the output barrier of the sub printing head 222. It is understandable that when the support material utilizes water to be material, the temperature control device controls the temperature of the water in the sub printing head 222 to not to be lower than 0° C. for preventing the water from being solidified at the mouth of the sub printing head 222 to form the output barrier of the sub printing head 222.

AS shown in FIG. 1, in the printing direction, the main printing head 221 of the printing assembly 2 is in front of the sub printing head 222. Furthermore, the printing assembly 2 comprises a printing control system. In the moving and printing process of the printing assembly 2, the printing control system can detect the positions of the main printing head 221 and the sub printing head 222, and independently controls the output operation of the main printing head 221 and the sub printing head 222 or stops the output operation.

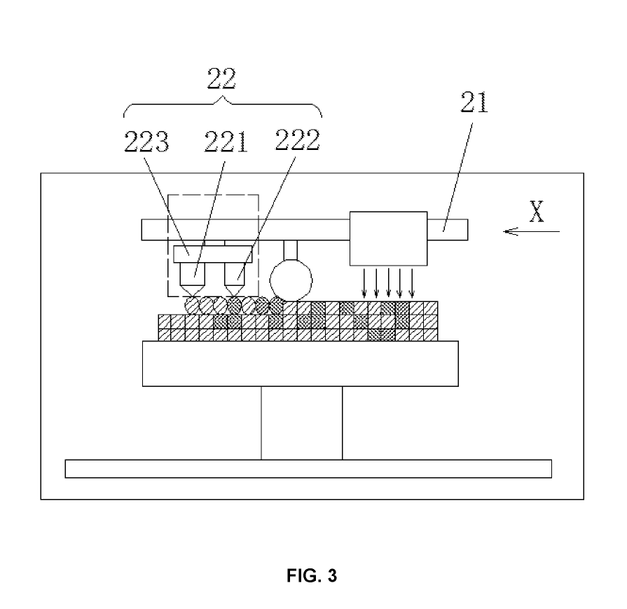

Please refer to FIG. 3. In another preferred embodiment of the present invention, the printing assembly 2 of the 3D printer further comprises a switch head 223, and the switch head 223 connects the main printing head 221 and the sub printing head 222 to the printing support 21, and switches positions of the main printing head 221 and the sub printing head 222. Furthermore, the printing assembly 2 of this embodiment comprises a printing control system. In the moving and printing process of the printing assembly 2, the printing control system can detect the positions of the printing assembly 2, and controls the switch head 223 to switch the positions of the main printing head 221 and the sub printing head 222 (namely, it determines whether the photosensitive resin 4 or the water 5 is required according to the printing position of the printing assembly 2, and then rotates the main printing head 221 or the sub printing head 222 to the printing position, and rotates the other printing head out of the printing position). Meanwhile, it can independently control the output operation of the main printing head 221 and the sub printing head 222 or stop the output operation.

Furthermore, the curing lamp assembly 24 of the 3D printer described in the embodiment of the present invention comprises a LED ultraviolet light source. The heat generated by the LED ultraviolet light source is small, and the lifetime is long, and the volume is small. The installation position in the 3D printer can be flexibly adjusted and the influence to the printing temperature inside the printing chamber 1 is small. Moreover, a spotlight device can be added on the LED ultraviolet light source. Thereby, the irradiation position of the light can be controlled more accurately to achieve the printing and curing effect in the 3D printing process.

Moreover, the loading platform 3 of the 3D printer described in the embodiment of the present invention comprises a low temperature assembly, and the low temperature assembly controls a temperature of a loading surface of the loading platform 3 to be lower than the solidification temperature of the support material. It ensures that the support material which utilizes the water and contacts with the loading surface will not melt. Here, the loading surface is the contact surface of the loading platform 3 with the photosensitive resin and the support material. It is understandable that when the support material utilizes water to be material, the temperature of the loading surface is lower than 0° C.

The embodiment of the present invention further provides a 3D printing method, which utilizes the 3D printer described in the aforesaid embodiments for printing, comprising the printing steps of:

printing the photosensitive resin and the support material in the printing chamber to form a model, and the photosensitive resin forms the model mainbody under irradiation of the curing lamp assembly, and the support material is solidified and supports the model mainbody at the printing temperature lower than the solidification temperature of the support material;

taking out the model, and removing the support material in an environment of which a temperature is higher than the solidification temperature of the support material.

In the 3D printer of this embodiment, the support material can be solidified after being printed by controlling the printing temperature in the printing chamber, and thus to realize the fixture and support to the model mainbody. The entire process is simple and highly efficient, and is beneficial for promoting the printing efficiency.

Meanwhile, only needed is to take out the model from the 3D printer, and put the same in an environment of which the temperature is higher than the solidification temperature of the support material, the support material will spontaneously melt. The remove procedure of the support material is fast and simple, and will not cause damage to the model mainbody. The printing quality of the model mainbody can be ensured.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A 3D printer, comprising a printing chamber, and the printing chamber comprises a printing assembly and a loading platform inside, and the printing assembly is located above the loading platform, and the printing assembly comprises a printing support and a printing head assembly and a curing lamp assembly connected on the printing support, and the printing support is moved along a printing direction, and in the printing direction, the printing head assembly is in front of the curing lamp assembly, and the printing head assembly comprises a main printing head of printing a model mainbody and a sub printing head of printing support material, and material of the model mainbody is photosensitive resin, and a printing temperature inside the printing chamber is lower than a solidification temperature of the support material, and the support material is solidified at the printing temperature.

2. The 3D printer according to claim 1, wherein the support material is water, and the printing temperature is lower than 0° C.

3. The 3D printer according to claim 1, wherein the printing assembly further comprises a flattening assembly connected on the printing support, and the flattening assembly is positioned between the printing head assembly and the curing lamp assembly.

4. The 3D printer according to claim 3, wherein the flattening assembly comprises a flattening roller and a supporting frame connected to the flattening roller and the printing support.

5. The 3D printer according to claim 4, wherein an interior of the flattening roller and an interior of the supporting frame are hollow and communicate with each other, and the interior of the flattening roller and the interior of the supporting frame are filled with cooling material of which a temperature is lower than the solidification temperature.

6. The 3D printer according to claim 1, wherein the sub printing head comprises a temperature control device of controlling the support material in the sub printing head to remain to be liquid.

7. The 3D printer according to claim 1, wherein in the printing direction, the main printing head is in front of the sub printing head.

8. The 3D printer according to claim 1, wherein the printing assembly further comprises a switch head, and the switch head connects the main printing head and the sub printing head to the printing support, and the switch head switches positions of the main printing head and the sub printing head.

9. The 3D printer according to claim 1, wherein the loading platform comprises a low temperature assembly, and the low temperature assembly controls a temperature of a loading surface of the loading platform to be lower than the solidification temperature of the support material.

10. A 3D printing method, wherein the 3D printing method employs a 3D printer for printing, and the 3D printer comprises a printing chamber, and the printing chamber comprises a printing assembly and a loading platform inside, and the printing assembly is located above the loading platform, and the printing assembly comprises a printing support and a printing head assembly and a curing lamp assembly connected on the printing support, and the printing support is moved along a printing direction, and in the printing direction, the printing head assembly is in front of the curing lamp assembly, and the printing head assembly comprises a main printing head of printing a model mainbody and a sub printing head of printing support material, and material of the model mainbody is photosensitive resin, and a printing temperature inside the printing chamber is lower than a solidification temperature of the support material, and the support material is solidified at the printing temperature.
specific printing steps of the 3D printing method comprises:
printing the photosensitive resin and the support material in the printing chamber to form a model, and the photosensitive resin forms the model mainbody under irradiation of the curing lamp assembly, and the support material is solidified and supports the model mainbody at the printing temperature lower than the solidification temperature of the support material;
taking out the model, and removing the support material in an environment of which a temperature is higher than the solidification temperature of the support material.

11. The 3D printing method according to claim 10, wherein the support material is water, and the printing temperature is lower than 0° C.

12. The 3D printing method according to claim 10, wherein the printing assembly further comprises a flattening assembly connected on the printing support, and the flattening assembly is positioned between the printing head assembly and the curing lamp assembly.

13. The 3D printing method according to claim 12, wherein the flattening assembly comprises a flattening roller and a supporting frame connected to the flattening roller and the printing support.

14. The 3D printing method according to claim 13, wherein an interior of the flattening roller and an interior of the supporting frame are hollow and communicate with each other, and the interior of the flattening roller and the interior of the supporting frame are filled with cooling material of which a temperature is lower than the solidification temperature.

15. The 3D printing method according to claim 10, wherein the sub printing head comprises a temperature control device of controlling the support material in the sub printing head to remain to be liquid.

16. The 3D printing method according to claim 10, wherein in the printing direction, the main printing head is in front of the sub printing head.

17. The 3D printing method according to claim 10, wherein the printing assembly further comprises a switch head, and the switch head connects the main printing head and the sub printing head to the printing support, and the switch head switches positions of the main printing head and the sub printing head.

18. The 3D printing method according to claim 10, wherein the loading platform comprises a low temperature assembly, and the low temperature assembly controls a temperature of a loading surface of the loading platform to be lower than the solidification temperature of the support material.
